(19) United States
(12) Patent Application Publication
(10) Pub. No.: US 2026/0044795 A1
(43) Pub. Date: Feb. 12, 2026

(54) SYSTEMS AND METHODS FOR CAREER TRANSITION PLANNING AND FACILITATION

(71) Applicant: Vitality Collaborative, Inc., Herndon, VA (US)

(72) Inventors: Nicholas Ashley Vandre, Pinehurst, NC (US); Kendall James Wouters, Southern Pines, NC (US)

(21) Appl. No.: 19/297,348

(22) Filed: Aug. 12, 2025

Related U.S. Application Data
(60) Provisional application No. 63/682,323, filed on Aug. 12, 2024.

(51) Int. Cl. G06Q 10/0631; G06Q 10/1053

(52) U.S. Cl. CPC G06Q 10/063114; G06Q 10/1053

(57) ABSTRACT

Systems and methods are disclosed for planning and facilitating career transitions, also referred to herein as a career management platform. In some cases, such systems and methods include automatically preparing customized career transition materials. While certain aspects and features of the present disclosure may be especially suitable for use by service members and veterans transitioning into new careers, the disclosed systems and methods can be used to aid any individuals in career transitions.

### CROSS-REFERENCE TO RELATED APPLICATIONS

This application claims priority under 35 U.S. C. § 119 to U.S. Provisional Application No. 63/682,323, titled “Systems and Methods for Career Transition Planning and Facilitation” filed on Aug. 12, 2024, the contents of which are incorporated herein by reference.

### TECHNICAL FIELD

The present disclosure relates generally to knowledge management platforms, and, more specifically, to platforms for generating career transition plans and materials.

### BACKGROUND

Career transition planning can be a complex and daunting task for many individuals. Traditionally, individuals receive generic advice and are presented with an overload of options that do not account for the unique circumstances of individual. There exists a need for a personalized approach that considers specific factors influencing an individual's career transition plans and leverages publicly available information to enhance the planning process and facilitate an individual's career transition. Moreover, users may benefit from having a partner who can assist with various steps in the process, as well as curated organizations that offer support for career transition goals.

According to one specific example, military transition planning can be a daunting and complex process, often involving generic advice that fails to account for individual circumstances. The overwhelming array of options and information can lead to confusion and suboptimal decisions for the service member and their spouse, family, etc. Traditional methods do not effectively leverage publicly available information or provide personalized guidance, making the transition process even more challenging. The implications of this leads to underemployment and poor income potential once leaving U.S. military. The present disclosure provides a solution for this and other problems.

### BRIEF SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, supplemented by this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Embodiments of the present disclosure include a computer-implemented method, includes receiving personal information associated with a user, generating a user profile associated with the user based at least in part on the received personal information, the user profile indicative of one or more career transition goals, analyzing the user profile to generate a set of key parameters, generating a customized career transition plan based at least in part on the user profile and the key parameters, and outputting a graphical user interface showing the customized career transition plan.

The computer-implemented method may also include where generating the customized career transition plan includes accessing publicly available information from one or more publicly available resources. The computer-implemented method may also include where generating the customized career transition plan includes accessing organizational information from one or more organization systems.

The computer-implemented method may also include where the user profile includes (i) demographic information, (ii) health-related information, (iii) career-related information, (iv) information about the user's family, (v) information about the user's finances, or (vi) any combination of (i)-(v).

The computer-implemented method may also include where the set of key parameters includes (i) information about family and dependents of the user, (ii) information about current financial assets and liabilities of the user, (iii) information about a desired career transition timeframe for the user, (iv) information about a preferred location for a career transition for the user, (v) information about motivations and reasons for the one or more career transition goals of the user, or (vi) any combination of (i)-(v).

The computer-implemented method may also include where generating the career transition plan includes identifying one or more available resources as being beneficial for the user to achieve the one or more career transition goals, where the career transition plan includes a recommendation associated with the identified one or more available resources. The computer-implemented method may also include where generating the career transition plan includes identifying one or more potential career targets based at least in part on the user profile and the set of key parameters, where the career transition plan includes a recommendation associated with the identified one or more potential career targets.

The computer-implemented method may also include further includes receiving supplemental information from a support user, the supplemental information usable to (i) update the user profile, (ii) update the set of key parameters, (iii) update the career transition plan, (iv) update progress of one or more steps of the career transition plan, or (v) any combination of (i)-(iv). The computer-implemented method may also include further includes: receiving tracking information indicative of progress of one or more steps of the career transition plan, and updating the graphical user interface based at least in part on the tracking information. The computer-implemented method may also include further includes receiving tracking information indicative of progress of one or more steps of the career transition plan, and updating the career transition plan based at least in part on the tracking information.

The computer-implemented method may also include further includes generating customized career transition materials. The computer-implemented method may also include where generating customized career transition materials includes generating a customized resumé associated with the user based at least in part on the user profile and the key parameters. The computer-implemented method may also include where generating the customized resumé is further based at least in part on a selected career target.

A system includes a control system including one or more processors, and a memory having stored thereon machine readable instructions, where the control system is coupled to the memory, and any of the aforementioned methods is implemented when the machine executable instructions in the memory are executed by at least one of the one or more processors of the control system.

A computer program product embodied on a non-transitory computer readable medium and includes instructions which, when executed by a computer, cause the computer to carry out any of the aforementioned methods.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments and are therefore not to be considered as limitations on the scope of the various embodiments or claims.

FIG. 1 is a schematic diagram of a computing environment, according to certain aspects of the present disclosure.

FIG. 2 is a block diagram of a system, according to certain aspects of the present disclosure.

FIG. 3 is a flowchart depicting a process for using a career management platform, according to certain aspects of the present disclosure.

FIG. 4A is an example set of graphical user interfaces for interacting with a career management platform, according to certain aspects of the present disclosure.

FIG. 4B is another example set of graphical user interfaces for interacting with a career management platform, according to certain aspects of the present disclosure.

FIG. 4C is another example set of graphical user interfaces for interacting with a career management platform, according to certain aspects of the present disclosure.

FIG. 4D is an example graphical user interface for interacting with a career management platform, according to certain aspects of the present disclosure.

FIG. 5 is a block diagram of an example system architecture for implementing features and processes of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” or any logical combination thereof.

Systems and methods are disclosed for planning and facilitating career transitions, also referred to herein as a career management platform. In some cases, such systems and methods include automatically preparing customized career transition materials. While certain aspects and features of the present disclosure may be especially suitable for use by service members and veterans transitioning into new careers, the disclosed systems and methods can be used to aid any individuals in career transitions.

By way of example, the career management platform leverages advanced assessment methodologies and curated resources to provide personalized, actionable career transition plans. By integrating support user features and generating custom resumés tailored to specific job applications, the platform ensures a comprehensive and user-centric approach to career transitions.

According to some aspects of the present disclosure, the career management platform is referred to as a “Knowledge Management Platform,” which addresses present challenges by offering a service member or veteran a mobile application that customizes career transition steps and resources based on a detailed assessment. The detailed assessment includes one or more of a user's five “Ws” (who, what, when, where, and why). This personalized approach ensures that users receive relevant and timely guidance tailored to their unique needs and circumstances.

According to some aspects of the present disclosure, the career management platform addressing unique needs of each user through personalized assessments, curated resources, and comprehensive support features. By leveraging artificial intelligence technology and publicly available information, the career management platform provides an efficient, effective, and user-friendly solution to the challenges of military transition planning for the service member, veteran, and their family.

The career management platform can be embodied on any suitable computing device or group of computing devices. In some cases, the career management platform is intended to be accessed via a mobile application, allowing a user to interact with the platform from the convenience of their own user device (e.g., smartphones, tablets, personal computers, etc.) and from any suitable location.

As used herein, the term career transition is intended to include (i) starting a new job at a new organization, (ii) starting a new job at a current organization, such as a new position at the individual's current employer, (iii) expanding or altering an individual's current job responsibilities (e.g., a transition from the individual's current job responsibilities to a new combination of job responsibilities, despite no change in title), or (iv) and combination of (i)-(iii).

A user profile can be created for each individual making use of the platform. The user profile can include personal information provided by the user, provided by a support user, and/or pulled from external sources. In some cases, the platform can present questions to the user or a support user with questions to obtain specific types of personal information. In some cases, the platform can access an external source (e.g., publicly available resources, private resources accessible with proper permissions, etc.) to obtain some or all of the personal information. Personal information can include information such as the user's age, current employment status, financial situation, and career transition goals. In some cases, other types of personal information can be used. Personal information can include (i) demographic information (e.g., age, gender, etc.), (ii) health-related information (e.g., disability status, physical limitations, etc.), (iii) career-related information (e.g., previous career information, applicable qualifications and certifications, current career information, career transition goals, etc.), (iv) other personal information (e.g., information about the user's family, information about the user's finances, etc.), or (v) any combination of (i)-(iv).

The platform can analyze the user profile to determine certain key parameters associated with the user's career transition needs. These key parameters can include (i) information about the user's family and dependents (“Who”), (ii) information about the user's current financial assets and liabilities (“What”), (iii) the user's desired career transition timeframe (“When”), (iv) the user's preferred location for career transition (“Where”), (v) the user's motivations and reasons for specific career transition goals (“Why”), or (vi) any combination of (i)-(v). In some cases, questions or other prompts presented to a user or support user when building the user profile can be designed to obtain information that would be useful in determining one or more key parameters.

The platform can generate a customized career transition plan for a user based on the key parameter(s), and optionally additional information, such as specific user profile information and/or job availability data. The customized career transition plan can include various steps that the user can take to achieve their career transition goals. These steps can be generated and ordered specifically for the user. For example, specific actions can be tailored to the user's profile (e.g., finishing a certification that the user had previously started but never completed). As another example, various actions can be prioritized and ordered based on one or more of the key parameters (e.g., actions can be ordered based on the user's location and the current timing and desired transition timeframe of the transition plan). The transition plan can include recommendations for resources that would be beneficial for the user's career transition, such as suggestions for financial advisors, investment opportunities, insurance options, travel options, grants, internships, and other relevant resources. In some cases, a customized career transition plan can be generated and thereafter used statically by the user (e.g., the steps and their priority/order will not change over time). In other cases, however, the customized career transition plan can be dynamically updated based on any suitable information, such as based on (i) updates to the user's profile; (ii) updated key parameters; (iii) updated available resources, (iv) updated job availability information, (v) updated transition plan generation models, and the like.

The platform can capture publicly available information (PAI) from external sources (e.g., via the internet) and curate that information to provide users with relevant and up-to-date information.

The platform can provide access for a support user to support a primary user, such as by assisting in the generation, management, and/or implementation a user's career transition plan. The user can extend or revoke access to the support user as necessary. Examples of support users can include spouses, partners, parents, children, caregivers, and the like. In an example, a user's career transition plan may include a series of steps to open new accounts to start building emergency funds for the career transition, in which case the user can provide support user access to their spouse to be able to interact with the user's career transition plan to view the relevant steps and/or mark the relevant steps as completed or in progress.

In some cases, the user's career transition plan can include additional steps that are designated to a particular support user. For example, a user's career transition plan may include a step designated to the spouse to have the spouse check in on the user's progress at certain intervals. In some cases, steps in a user's career transition plan that are designated to a support user can be hidden from the user's view.

The platform can curate and suggest organizations that support the user's career transition goals. For example, if a user is interested in a particular career transition that would require certain skills that the user does not currently possess, the platform can suggest a local vocational training course that can help the user obtain those required skills.

The platform can track the user's progress towards their career transition goals. In some cases, tracking can be manually performed by receiving (prompted or unprompted) updates from the user or from a support user regarding specific steps of the career transition plan. In some cases, the platform can automatically track progress of one or more steps of a career transition plan, such as by monitoring a publicly available resource for an update related to the user. In some cases, the platform can semi-automatically track progress of one or more steps of a career transition plan, such as by automatically generating a prompt to a user inquiring about a certain step when it is likely that the user is completing or at least taking action on a certain step. For example, if a career transition plan includes a step to visit a particular organization, location data (e.g., from the user's user device) can be used to determine that the user was at the location of that organization, in which case the platform can prompt the user to inquire if the user visited that organization. As another example, if a career transition plan includes a step to perform an action by a particular deadline, the platform can automatically prompt the user to inquire if the user completed that step based on the deadline (e.g., in advance of the deadline, at the deadline, or after the deadline).

The platform can provide a graphical user interface (GUI) that allows users and/or support users to easily see and understand a user's progress through their customized career transition plan. The GUI can show various relevant information, such as a listing of steps in the career transition plan, information about how long steps are expected to take and/or expected completion dates for steps, information or materials needed to complete certain steps, or the like. In some cases, the GUI can dynamically filter steps in a career transition plan, such as to show only those steps associated with a particular location where the user will be visiting on a given day, or only those steps that must be completed before subsequent steps can be undertaken. Various graphics can be used to indicate to the user a sense of progress and encourage the user to complete the steps in the career transition plan.

The platform can send various notifications to the user and/or a support user, such as to remind the user of important deadlines, inform the user of important updates, or provide the user with opportunities relevant to their career transition plan. These notifications can be sent using any suitable technique, such as via an in-app push, a text message, an email message, a chat message, an automated phone call, a personal phone call (e.g., via automatically initiating a call between the user and an appropriate representative), and the like. Notifications can be initiated automatically based on various criteria in the user's profile, the user's key parameters, the user's customized career transition plan, or the like. In some cases, one or more notifications can be temporally initiated (e.g., initiated at a specific time, initiated within a specific window of time, initiated a specific amount of time following an event, and the like). In some cases, one or more notifications can be initiated by location (e.g., initiated based on the user's location or updates to the user's location). In some cases, one or more notifications can be initiated by updated information, such as obtaining updated job availability information. Notifications can be initiated automatically using other techniques, as well. In some cases, notifications can be manually initiated, such as by a support user (e.g., to send a notification to the user to perform an action) or by a third party (e.g., by a resource organization to remind all relevant users of a resource they provide, or by a potential employer to notify all relevant users of an employment opportunity).

The platform can generate various customized career transition materials, such as the customized career transition plan, customized job search terms, and a customized resumé. Customized resumés can be automatically generated based on the user's profile, the key parameters, and/or a specific career target (e.g., a specific job to which the user is applying). In some cases, the user's profile includes a base resumé, which can be used in the generation of the customized resumé. The customized resumé can be specifically tailored to a particular career target to ensure the resumé aligns with the job requirements and highlights relevant skills and experiences. Customized resumés can be automatically generated and printed (e.g., for mailing or hand-delivery to a career target) or can be automatically generated and stored electronically (e.g., for later retrieval and/or for sending to a career target, such as via email). In some cases, the platform can store automatically generated customized resumés and provide access to the customized resumés via the internet (e.g., via a shared URL). In such cases, the user can opt to share the URL with a career target or other individual to provide them with access to a particular customized resumé. In some cases, the user can enable permission controls to restrict access to a particular customized resumé unless the accessing party provides a correct password or the accessing party accesses the customized resumé using permitted credential. For example, a user can associated a customized resumé with a particular domain name (e.g., employer.com) such that only accessing parties with login credentials associated with that domain name (e.g., login credentials created by having a party desiring access click or otherwise engage a link that was sent to an email address at that particular domain) can access that particular customized resumé.

In some cases, the platform can update a customized resumé in response to changes to any relevant user information (e.g., the user's profile, the user's key parameters, the user's career transition plan, etc.) or changes to a career target's requirements. For example, if a user completes a certification course after having generated a customized resumé for a particular career target, the platform can send a notification to the user or can automatically generate an updated customized resumé showing that the user now has that particular certification. An updated customized resumé can be made available to the user and/or an appropriate third party (e.g., an accessing party at the career target), such as via an email attachment, an in-app download, a link to a URL, and the like.

The platform can generate customized job search terms for a user based on the user's profile, the key parameters, and/or the user's career transition plan. The customized job search terms can be designed to more effectively identify jobs that fit the user's career transition goals. In some cases, generation of customized job search terms can be based at least in part on one or more current and/or one or more past job listings that would fir the user's career transition goals.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

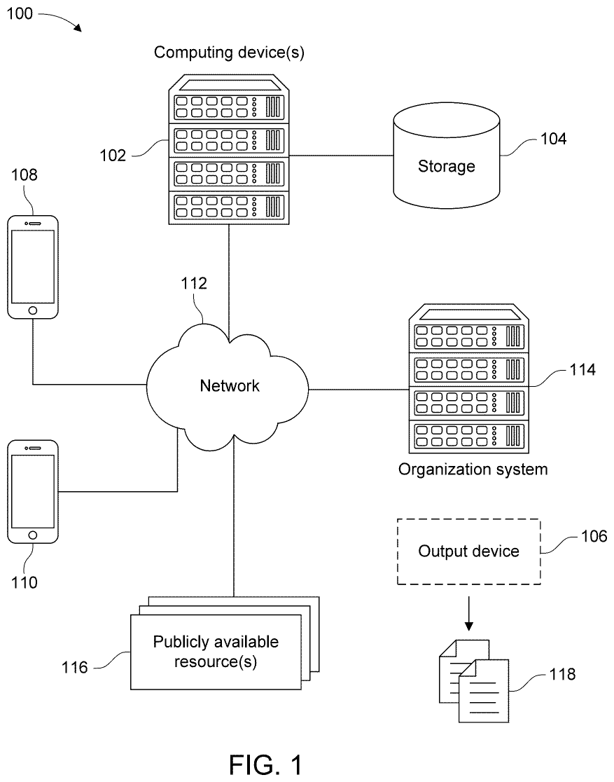

FIG. 1 is a schematic diagram of a computing environment 100, according to certain aspects of the present disclosure. The computing environment 100 can be used to implement a career management platform as disclosed in further detail herein. The computing environment 100 can include a computing device 102, a storage 104, an output device 106, a user device 108, a support user device 110, a network 112, an organization system 114, and a publicly available resource 116. In some cases, however, the computing environment 100 can include fewer or additional components. For example, in some cases, the entire career management platform can be implemented on a single user device 108, in which case the computing device 102, the storage 104, and the output device 106 may be omitted. In some cases, the support user device 110 is omitted if no support user is participating.

As used herein, the term computing device is intended to include any suitable computing device, such as a personal computer, a smartphone, a tablet computer, a wearable computing device, a server, and the like.

The computing device 102, which itself can be implemented on one or more computing devices, can act as a backend server for the career management platform. The computing device 102 can perform various functions, such as initiating notifications, receiving user information from various sources, analyzing user profiles to determine key parameters, generate customized career transition plans, generate customized resumés, generate customized search terms, and the like. The computing device 102 can be coupled to a storage 104 to store any suitable information, such as user profiles, user career transition plans, local copies of information obtained from publicly available resources 116, local copies of information obtained from organization systems 114, and the like. In some cases, storage 104 can contain program code for performing various operations as disclosed herein.

A user device 108 can access the career management platform, such as via a native application on the user device 108 or via a webpage. In some cases, the user device 108 can communicate with the computing device 102 to perform the various features of the career management platform as disclosed herein. The user device 108 can be any suitable computing device used by a user, such as a smartphone, a tablet computer, a personal computer, or the like. The user device 108 can be a single device, although that need not always be the case. In some cases, a user can access the career management platform via multiple devices, such as a smartphone and a personal computer.

A support user device 110 can be the same as or similar to user device 108, but for use by a support user instead of the user. In some cases, a support user and a user can make use of the same device. In some other example cases, a given computing device can serve as the user device 108 during a first period of time, and the same given computing device can serve as the support user device 110 during a second period of time, and vice-versa.

The user device 108, support user device 110, and computing device 102 can communicate with one another via a network 112 (e.g., the Internet, a wireless communications network, or a wired communications network). In some cases, the computing environment 100 can include one or more organization systems 114 coupled to and accessible by the network 112. An organization system 114 can be a server or other computing device storing information for an organization, such as an employer or job listing aggregator. For example, an organization system 114 can store information about available job listings that can be accessed via the network 112.

In some cases, the computing environment 100 can include one or more publicly available resources 116. A publicly available resource 116 can be a server or other computing device storing publicly available information, such as information about grant programs or vocational training programs. In some cases, a publicly available resource 116 can be embodied in an organization system 114, although that need not always be the case.

In some cases, the computing environment 100 can include an output device 106. The output device 106 can be used to generate customized files 118, such as customized resumés, customized career transition plans, customized job search terms, and the like. In some cases, the output device 106 can be coupled to the user device 108, the computing device 102, the support user device 110, or the organization system 114. In some cases, the output device 106 is a printer, which can be used to manually or automatically create printouts of customized resumés.

While the computing environment 100 is depicted with certain components in FIG. 1, in some cases computing environment 100 can include additional components, fewer components, and/or different components.

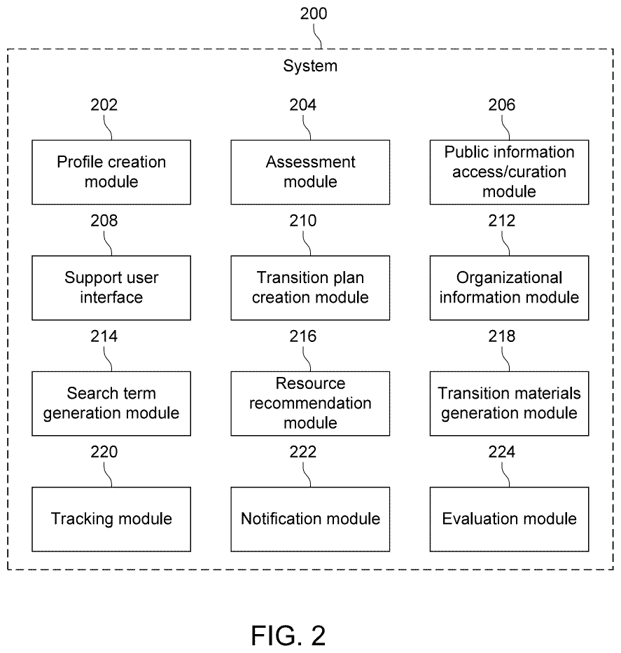

FIG. 2 is a block diagram of a system 200, according to certain aspects of the present disclosure. The system 200 can include a profile creation module 202, an assessment module 204, a public information access/curation module 206, a support user interface module 208, a transition plan creation module 210, an organizational information module 212, a search term generation module 214, a resource recommendation module 216, a transition materials generation module 218, a tracking module 220, a notification module 222, and an evaluation module 224.

The profile creation module 202 is responsible for creating a user's profile. For example, the profile creation module 202 can receive personal information from the user. Personal information may include (i) demographic information, (ii) health-related information, (iii) career-related information, (iv) information about the user's family, (v) information about the user's finances, or (vi) any combination of (i)-(v). The personal information may also include information associated with a military status of the user. For example, the user can indicate, to the profile creation module 202, that they are currently an active-duty servicemember, a retired service member, a civilian, or a support user.

The assessment module 204 is responsible for analyzing the user's profile to determine the key parameters. Based on the assessment of the assessment module 204, a persona can be created for the user. This persona includes a detailed assessment of the user, the goals of the user, and the five “Ws” of the user (who, what, when, where, and why).

The public information access/curation module 206 is responsible for accessing public information from publicly available resources 116, storing the public information, and curating the public information for each user based on the user's user profile and/or key parameters. Public information can be accessed via a network, such as network 112.

The support user interface module 208 is responsible for managing support users and their interactions with the career management platform.

The transition plan creation module 210 is responsible for generating customized career transition plans, such as from the user's profile and/or the user's key parameters.

The organizational information module 212 is responsible for accessing and storing organizational information.

The search term generation module 214 is responsible for generating customized job search terms, such as from the user's profile and/or the user's key parameters.

The resource recommendation module 216 is responsible for maintaining information about available resources and generating customized recommendations for certain resources for users.

The transition materials generation module 218 is responsible for generating various transition materials, such as customized resumés.

The tracking module 220 is responsible for tracking and maintaining information about users'progress through their respective career transition plans.

The notification module 222 is responsible for initiating notifications, such as notifications to users, to support users, and/or to third parties (e.g., employers).

The evaluation module 224 is responsible for evaluating a user's career transition. For example, the evaluation module 224 can initiate a prompt to a user to evaluate the user's satisfaction with their new career after a career transition made using the career management platform. Such evaluations can be used to improve various modules of the system 200, such as the transition plan creation module 210, the search term generation module 214, the resource recommendation module 216, or the transition materials generation module 218.

While the system 200 is depicted with certain modules, in some cases, the system 200 can include additional modules, fewer modules, and/or other modules. While depicted as separate modules, in some cases two or more modules of the system 200 can be combined into a single module.

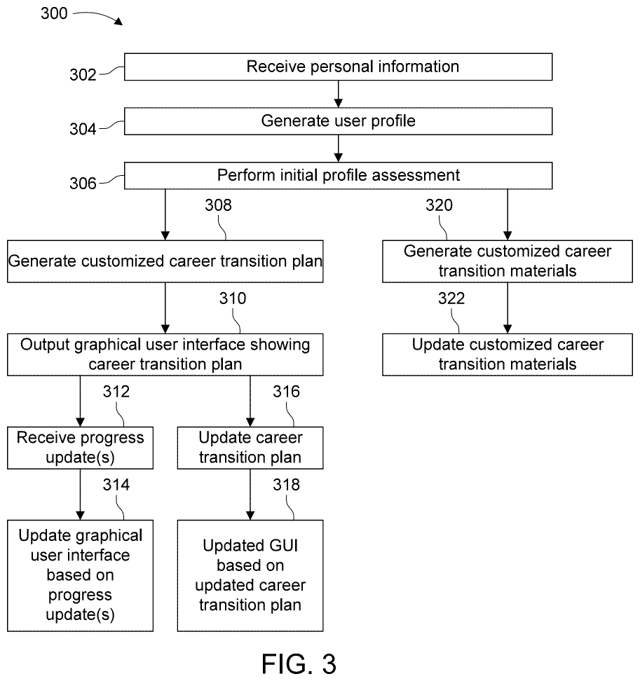

FIG. 3 is a flowchart depicting a process 300 for using a career management platform, according to certain aspects of the present disclosure. Process 300 can be performed using any suitable computing device or combination of computing devices, such as computing device 102 of FIG. 1.

At block 302, personal information about a user can be received. Personal information can be received directly from the user (e.g., via responses to prompts displayed to the user), can be received from a support user, or can be received from an external source (e.g., public records from publicly available resources, private records when permitted, such as medical records when the user provides appropriate permission). The personal information can be various types of information about the user that can be used to generate a user profile. For example, the personal information may include (i) demographic information, (ii) health-related information, (iii) career-related information, (iv) information about the user's family, (v) information about the user's finances, (vi) information about the user's military service, or (vii) any combination of (i)-(v). The personal information may also include information associated with a military status of the user. For example, the user can indicate, to the profile creation module 202, that they are currently an active-duty servicemember, a retired service member, a civilian, or a support user. The personal information may also include a military identifier such as a United States Military Occupation Specialty (MOS) code. In some example embodiments, the personal information can be received from a device such as user device 108 or support user device 110 via the network 112.

At block 304, a user profile can be generated. Generating a user profile at block 304 can include accessing and storing the received personal information. In some cases, generating the user profile can include identifying one or more pieces of absent information and prompting the user (or support user) for that missing information, which can then be received and used in the generation of the user profile.

At block 306, an initial assessment is performed. Performing the initial assessment can include analyzing the user profile to determine one or more key parameters. The key parameters can include (i) information about the user's family and dependents (“Who”), (ii) information about the user's current financial assets and liabilities (“What”), (iii) the user's desired career transition timeframe (“When”), (iv) the user's preferred location for career transition (“Where”), (v) the user's motivations and reasons for specific career transition goals (“Why”), or (vi) any combination of (i)-(v). Based on these key parameters and the user profile, a user persona is determined. A user persona includes information associated with the user, their key parameters, and a military status of the user. For example, a user may be determined to be (i) an active-duty servicemember, (ii) a veteran, (iii) a support user of a servicemember or veteran, or (iv) any combination of (i)-(iii).

The initial assessment of block 306 may also include a non-invasive state check. The non-invasive state check includes a mental and emotional assessment. The non-invasive state check may include one or more response metrics based on the user's responses to assessments. These assessments are presented to the user via the user device 108 and/or the support user device 110. Responses to the assessments can be received directly from the user (e.g., via responses to prompts displayed to the user), can be received from a support user, or can be received from an external source (e.g., public records from publicly available resources, private records when permitted, such as medical records when the user provides appropriate permission). In some example embodiments, the assessments include graphical user interface elements such as sliders, binary inputs, and symbolic representations of emotions and mental states. Responses to these assessments may include symbolic data, state data, and other nontextual information.

At block 308, a customized career transition plan can be generated. Generating the customized career transition plan can be based on the key parameters, the user profile, and/or the user persona. In some cases, generating a customized career transition plan can include accessing publicly available information from one or more external sources (e.g., internet-accessible public sources), for example the publicly available resources 116. In some cases, generating the customized career transition plan can include accessing organization information (e.g., a listing of current job postings) from one or more organization systems.

The customized career transition plan may also include a persona-based onboarding component. The persona-based onboarding is based at least on the user persona and may also be based on information associated with the key parameters and the user profile. Based on the user's persona, different onboarding materials may be included in the customized career transition plan. For example, an active duty servicemember may have their customized career plan based on the number of months remaining in their service. Likewise, a user whose persona is associated with a veteran status may have information related to military transition planning in their customized career transition plan. In some example embodiments the customized career transition plan may be targeted at a user whose persona indicates that they are undergoing a military transition to civilian life. In this scenario, the customized career transition plan would include goals, information, hyperlinks, and other information associated with civilian or federal employment. For example, the customized career transition plan would include an employment timeline with one or more steps intended to guide the user towards finding civilian employment, education, or entrepreneurship. Resources associated with this customized career transition plan could include job listings, educational opportunities, grants, financial planning resources, volunteer opportunities, and relocation resources. The information included in the customized career transition plan may also be based on the user profile and the key parameters.

In other example embodiments, the user persona indicates that the user intends to re-enlist or otherwise remain in the military. In this scenario, the customized career transition plan includes a military retention plan. The military retention plan includes information, goals, plans, and resources related to remaining in the military, advancing a military career, and achieving user goals regarding their military retention. For example, the military retention plan can include one or more re-enlistment options that detail how the user may remain in the military. Examples of re-enlistment options include continuing in the user's current military role, changing a military role of the user, options for MOS reassignment, pursuing a military commission or advanced training, or other options associated with the user remaining in the military. The military retention plan also includes resources related to the user's military career, such as educational opportunities, training opportunities, internal military resources, contacts within an organizational structure of the military, or other information.

At block 310, a graphical user interface (GUI) can be caused to be output (e.g., displayed) to a user. The GUI can show the career transition plan from block 308. The GUI can also show information related to the career transition plan from block 308, such as information from the publicly available resources 116.

At block 312, progress update information can be received. Progress updates can be provided by the user or by support users via the user device 108 or via the support user device 110. Receiving progress update information can include receiving any information indicative of progress of one or more steps in the career transition plan. In some cases, receiving progress update information can include receiving information indicative of a lack of progress of a step in the career transition plan. The progress update information can be received directly from a user (e.g., in response to a prompt or unprompted), from a support user, or from a third party. In some example embodiments, the progress update information may be determined by the system 200 and based on information associated with the user. For example, the system 200 may collect user information related to user activity on the career management platform. Based on an analysis of this user information, the system 200 may generate progress update information for the user.

At block 314, the GUI from block 310 can be updated based on the progress update information from block 312. For example, a progress indicator element may be updated to indicate the progress of the user. In some other example embodiments, updating the GUI from block 310 may also include transmitting a notification to the user or support users via the user device 108 or the support user device 110.

At block 316, the career transition plan can be updated. Updating the career transition plan can occur in response to new information being received, such as new information that would update the user's user profile, any of the user's key parameters, new publicly available information, new organizational information, and the like. For example, an update indicating that the user has now completed a certification, which can be added to the user's profile, can be used to update the career transition plan to account for the new certification, such as by adding new steps, removing unnecessary steps, and the like.

At block 318, the GUI from block 310 can be updated based on the updated career transition plan. For example, the GUI may be updated to indicate visually that the career transition plan has been updated. This can include highlighting or otherwise indicating to the user, via the updated GUI, which portions of the career transition plan have been updated. In some other example embodiments, updating the GUI from block 310 may also include transmitting a notification to the user or support users via the user device 108 or the support user device 110.

At block 320, customized career transition materials can be generated. Generating customized career transition materials can be based on the user's user profile and/or the user's key parameters. In some cases, generating customized career transition materials can be further based on publicly available information and/or organizational information. Generating the customized career transition materials can include generating a customized resumé, generating custom search terms, or the like. In some cases, generating the customized career transition materials can include automatically creating physical materials (e.g., printouts), although that need not always be the case. In some cases, generating the customized career transition materials can include automatically transmitting or otherwise making available electronic versions of the customized career transition materials. In some example embodiments, the system 200 may generate the customized career transition materials using a trained artificial intelligence (AI) or machine learning (ML) process. In other example embodiments, generating the customized career transition materials uses a trained generative AI process, such as a large-language model (LLM) or multimodal model.

At block 322, the customized career transition materials from block 320 can be updated. Updating the Updating the career transition plan can occur in response to new information being received, such as new information that would update the user's user profile, any of the user's key parameters, new publicly available information, new organizational information, and the like. For example, an update indicating that the user has now completed a certification, which can be added to the user's profile, can be used to update the career transition plan to account for the new certification, such as by adding new steps, removing unnecessary steps, and the like. Updating the customized career transition materials can include automatically creating new physical materials (e.g., new printouts with the updated career transition materials) and/or automatically transmitting or otherwise making available updated electronic versions of the updated customized career transition materials. In some cases, old versions of the career transition materials from block 320 can be deleted, can become inaccessible, or can be replaced by updated career transition materials once the updated career transition materials are created.

While process 300 is described with reference to various blocks in a particular order, in some cases, process 300 can include additional blocks, fewer blocks, or different blocks, optionally in a different order. For example, in some cases, a version of process 300 intended primarily for the creation of customized career transition materials might not include blocks 308, 310, 312, 314, 316, or 318. In another example, process 300 can include one or both of blocks 316 and 318 between blocks 312 and 314.

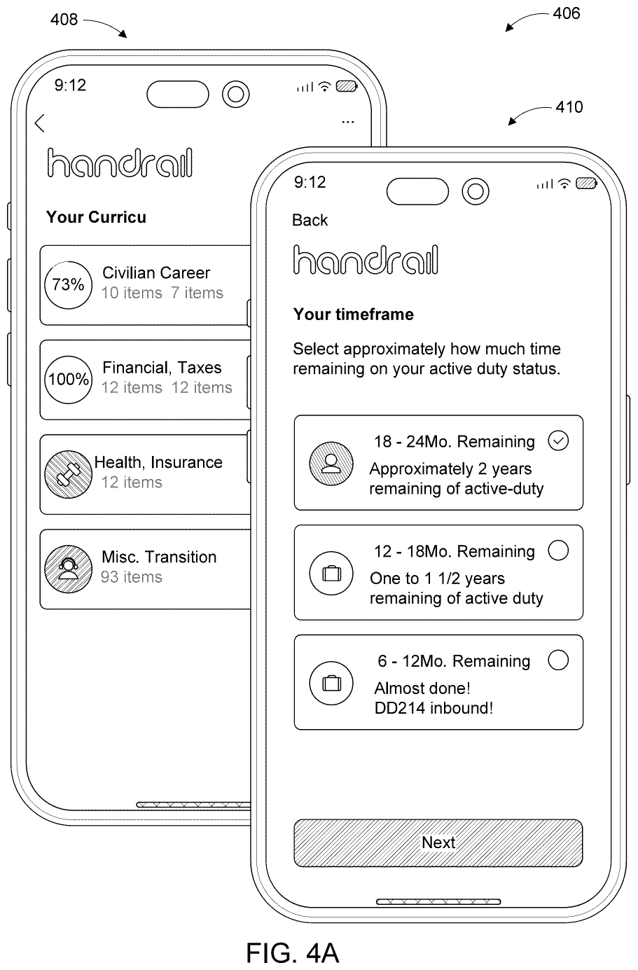

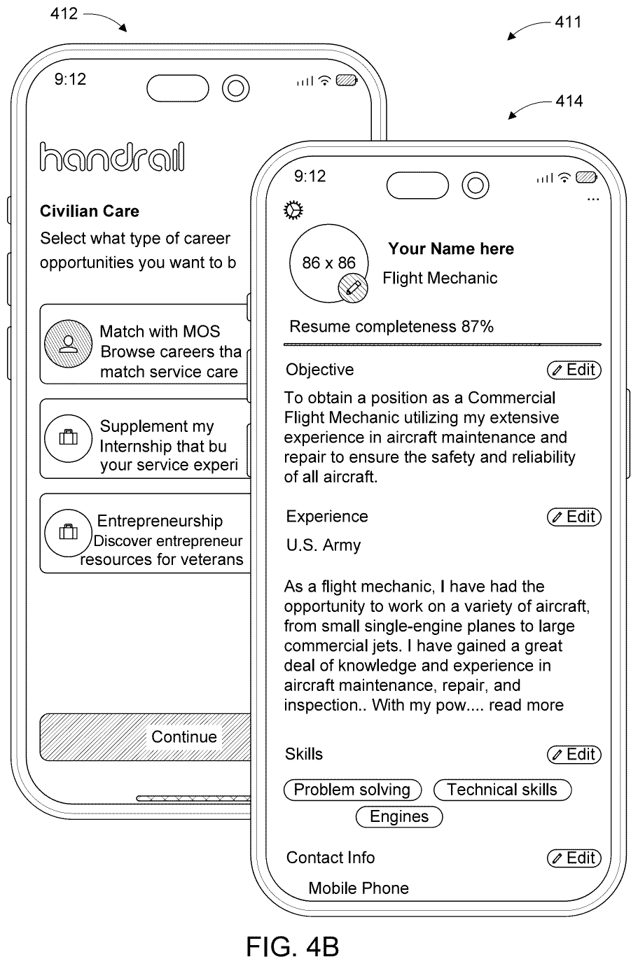

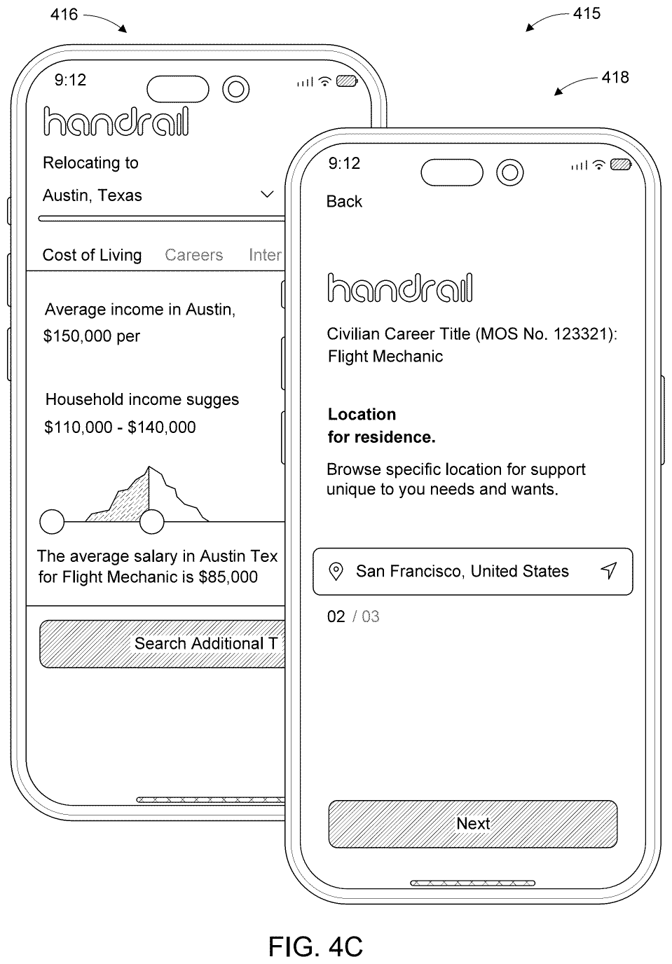

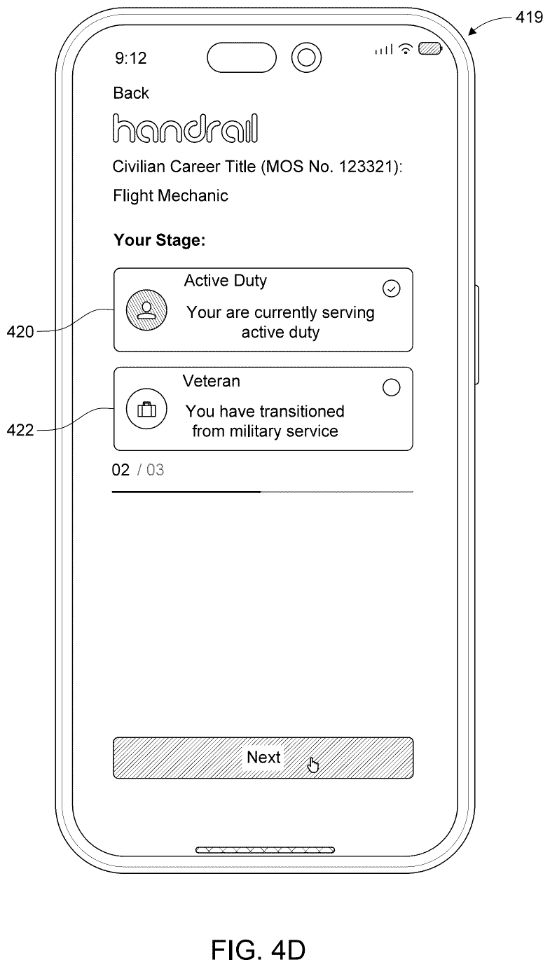

FIG. 4A is a set of graphical user interfaces 406 for interacting with a career management platform, according to certain aspects of the present disclosure. The series of graphical user interfaces 406 can be displayed on any suitable device, such as user device 108 of FIG. 1.

As depicted in the first interface 408, a personalized curriculum (e.g., a career transition plan and/or a military retention plan) can be displayed, showing categories of tasks to be performed by the user as part of planning for and/or otherwise managing their career transition. Each category can include one or more tasks to be completed as part of the career transition plan. Example tasks include completing forms, contacting individuals, creating accounts with organizations, and procuring tangible or intangible items. The percentage of tasks completed in a category can be displayed. For example, as shown, the user has the task category “Civilian Career Management” shown in one element of the first interface 408 with the percentage “73%” indicated. This percentage can be based on a determined completion percentage for the task category. In some example embodiments, the determined completion percentage is based on the user completing one or more of the tasks included in the corresponding category. A user can click, tap, or otherwise engage a category to bring up a list of tasks within that category, allowing a user to see what tasks need to be completed, to mark tasks as completed, and/or to otherwise interact with the personalized curriculum on a task level.

In some example embodiments, selecting a category may open a detailed view including instructions, resources, and other information associated with the one or more tasks included in the category. Each task in the category may have an interface element that shows information associated with the task. For example, a task in the “Civilian Career Management” category may be a lesson entitled “Understanding the differences between Federal and Civilian Resumés.” In the element associated with the task, the interface shows a summary describing the task, a progress indicator for the task, and other information associated with the given task. In some example embodiments, the detailed view may also show a list of resources related to the tasks included in the category. For example, the detailed view may show a list of career counselors, job boards, and resumé templates in the “Civilian Career Management” category. In some example configurations of the detailed view, at least a portion of the information associated with the tasks is received via a network such as the network 112. In other example configurations, at least a portion of the information associated with the tasks is generated by a trained artificial intelligence or machine learning process such as a large-language model or a neural network.

As depicted in the second interface 410 of FIG. 4A, in an onboarding process or at any suitable time, a user can select an approximate timeframe until their expected career transition. Generation of the customized career transition plan (e.g., such as at block 308 of FIG. 3) can be affected by the amount of time between when the career transition plan is generated and the expected career transition. For example, when a user has 12-24 months, or more, until their planned career transition, the career transition plan can focus more on proactive career and transition planning, including using available resources at times when they may be most valuable. As another example, when a user has 6-12 months until their planned career transition, the career transition plan can focus on education and training, such as to provide the user with advice and counseling to orient them to the coming transition. As another example, when a user has 6 months or fewer until their planned career transition, the career transition plan can focus on connecting users with potential employers and job opportunities, with resources useful for finding housing, with resources for managing disabilities, with family support resources, and the like. While not depicted in the second interface 410 in FIG. 4A, in some cases, a user can be in a post-transition period (e.g., a number of days or months since a career transition), in which case the career management platform and/or the career transition plan can still provide useful connections to networks, resources, and community members. In some other examples of the second interface 410 in FIG. 4, the timeframe information may also affect a military retention plan of the user. For example, if the user has 12-24 months, or more, until their planned re-enlistment, the military retention plan can focus more on proactive planning, such as advanced training or potential commissioning.

The information received by the second interface 410 associated with the timeframe of the user may also be based on the user persona determined at block 306 of FIG. 3. For example, the user persona may indicate a military status of the user, including information that indicates that the user is 12 months from the beginning of their career transition or military retention. In this example embodiment, the second interface 410 may have a timeframe option preselected based at least in part on the user persona.

FIG. 4B is another example set of graphical user interfaces 411 for interacting with a career management platform, according to certain aspects of the present disclosure. As depicted in the third interface 412, a selection screen can be presented to a user to determine what types of career opportunities or military retention opportunities most interest the user. For example, a user may be able to select (i) an option that is associated with career opportunities for which the user is most qualified and/or most likely to obtain; (ii) an option that is associated with career opportunities that supplement the user's experience; and/or (iii) an option focused on entrepreneurship resources. Users may also enter personal information that is then used to determine what types of career opportunities or military retention opportunities interest the user. For example, a user may enter their military role or expertise. This information can then be used to match the user to different opportunities that match their skillset. Likewise, the selection screen may pre-select an option based on information included in the user profile. For example, if the user's profile includes an MOS number, the third interface 412 may prepopulate the presented options with the MOS number or offer the user the ability to select an option that is associated with careers relating to the user's MOS number.

As depicted in the fourth interface 414, a resumé editor can be presented to a user to let them fill out various portions of a resumé for future use. In some cases, the resumé can be initially auto-generated as discussed in further detail herein. For example, the resumé may be based at least on the information included in the user profile and/or the user persona. The resumé may be generated based on this information by a trained artificial intelligence or machine learning process, such as an LLM. In some cases, the information provided by the user in this resumé editor can be used in the process of auto-generating further custom resumés. The resumé editor depicted in the fourth interface 414 may also include one or more progress indicators, or one or more indicators of metrics that are associated with the resumé. For example, the resumé editor may assess the content of the user's resumé and determine a “completeness” metric that is presented to the user in the fourth interface 414. As the user updates the resumé, or as the career management system auto-generates the resumé, the completeness metric will update, and the indicator of the completeness metric presented to the user will update accordingly. The career management system may also determine additional metrics that characterize the resumé, such as a metric that indicates how appropriate the resumé is for certain career options that the user has identified interest in. In some example embodiments, the fourth interface 414 includes indicators of one or more suggestions to the user to implement in the resumé displayed in the fourth interface 414. For example, the system may analyze the content of the resumé and determine one or more suggestions for the user to implement. These suggestions can be indicated in the fourth interface 414, and the user may select each of the suggestions and decide whether to implement the suggestion in the resumé. In some example embodiments, selecting a suggestion presents the user with an option to automatically update the resumé with the suggestion.

FIG. 4C is another example set of graphical user interfaces 415 for interacting with a career management platform, according to certain aspects of the present disclosure. As depicted in the fifth interface 416, a relocation planner screen can be presented to the user, displaying an option to select a relocation location (e.g., Austin, Texas). The user may select the relocation location, or the career management system may select the location based on information included in the user profile and/or the user persona. For example, the user may have indicated during user profile setup a home location. This home location may serve as a default relocation location in the fifth interface 416. Once a relocation location is selected, the relocation planner screen can provide various sections of information, such as information about cost of living at that location, information about careers opportunities at that location, and other useful information. This information can be retrieved from the storage 104, the publicly available resources 116, or from the internet via the network 112. The various information presented in the relocation planner screen can be generic or can be career-specific. For example, a user can select a particular career title (e.g., flight mechanic) and the relocation planner screen can present information (e.g., average salary) for that particular career title. Likewise, based on information included in the user profile and/or the user persona, the fifth interface 416 may present certain information associated with the information included in the user profile and/or the user persona and associated with the selected location.

As depicted in the sixth interface 418, a relocation selection screen can be presented to the user, allowing the user to select a location for more information. In some cases, a user's choice for career title (e.g., flight mechanic) can inform what location options are available to be selected, although that need not always be the case. In some other example embodiments, the location options may be based on information included in the user profile and/or the user persona. The user can select location through any suitable technique, such as geolocation or by typing in a location.

FIG. 4D is an example graphical user interface 419 for interacting with a career management platform, according to certain aspects of the present disclosure. FIG. 4D depicts a military stage or military status selection screen of the career management system. The information received from the user's selection in the seventh interface 419 can be used by exemplary processes such as those depicted in block 306 of FIG. 3. In some example embodiments, the information received from the user's selection in the seventh interface 419 is included in the user profile and/or used to establish the user persona. In the seventh interface 419, one or more graphical elements associated with military statuses such as active duty status element 420 or veteran status element 422 are shown. The user may select at least one of these elements to indicate to the career management system a military status. In some example embodiments, the user may also be prompted to add additional information about their military status upon the selection of one of the elements of the seventh interface 419. For example, the user may be prompted to indicate a future plan associated with the user's military status, or the user may be prompted to indicate an intention to stay in the military.

While various interfaces are depicted in the series of graphical user interfaces 406 of FIGS. 4A-4D, it will be understood that other interfaces can be used to implement the various aspects and features of the present disclosure.

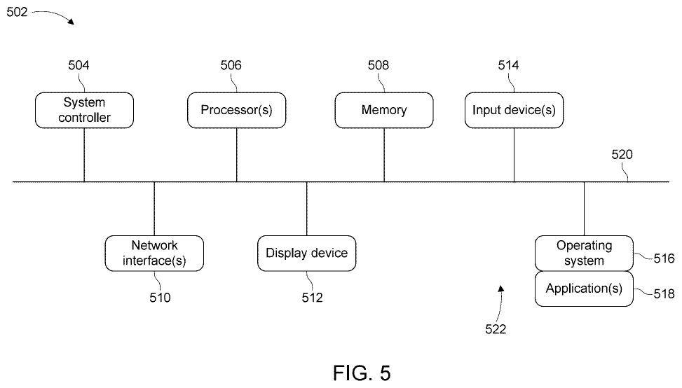

FIG. 5 is a block diagram of an example system architecture 502 for implementing features and processes of the present disclosure, such as those described in further detail herein. The features and processes disclosed herein can be implemented using one or multiple instances of 502. The system architecture 502 can be used to implement a server (e.g., a cloud-accessible server), a user device (e.g., a smartphone or personal computer), or any other suitable device for performing some or all of the aspects of the present disclosure. The system architecture 502 can be implemented on any electronic device that runs software applications derived from compiled instructions, including without limitation personal computers, servers, smart phones, electronic tablets, game consoles, email devices, and the like. In some implementations, the system architecture 502 can include one or more processors 506, one or more input devices 514, one or more display devices 512, one or more network interfaces 510, and one or more computer-readable media 522. Each of these components can be coupled by bus 520.

Display device 512 can be any known display technology, including but not limited to display devices using Liquid Crystal Display (LCD) or Light Emitting Diode (LED) technology. Processor(s) 802 can use any known processor technology, including but not limited to graphics processors and multi-core processors. Input device 514 can be any known input device technology, including but not limited to a keyboard (including a virtual keyboard), mouse, track ball, and touch-sensitive pad or display. In some cases, audio inputs can be used to provide audio signals, such as audio signals of an individual speaking. Bus 520 can be any known internal or external bus technology, including but not limited to ISA, EISA, PCI, PCI Express, NuBus, USB, Serial ATA or Fire Wire.

Computer-readable medium 522 can be any medium that participates in providing instructions to processor 506 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-readable medium 522 can include various instructions for implementing operating system 516 and applications 518 such as computer programs. The operating system 516 can be multi-user, multiprocessing, multitasking, multithreading, real-time and the like. The operating system 516 performs basic tasks, including but not limited to: recognizing input from input device 514; sending output to display device 512; keeping track of files and directories on computer-readable medium 522; controlling peripheral devices (e.g., storage drives, interface devices, etc.) which can be controlled directly or through an I/O controller; and managing traffic on bus 520. Computer-readable medium 522 can include various instructions for implementing firmware processes, such as a BIOS. Computer-readable medium 522 can include various instructions for implementing any of the processes described herein.

Memory 508 can include high-speed random access memory and/or non-volatile memory, such as one or more magnetic disk storage devices, one or more optical storage devices, and/or flash memory (e.g., NAND, NOR). The memory 508 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 508 can store an operating system, such as Darwin, RTXC, LINUX, UNIX, OS X, WINDOWS, or an embedded operating system such as Vx Works.

System controller 504 can be a service processor that operates independently of processor 506. In some implementations, system controller 504 can be a baseboard management controller (BMC). For example, a BMC is a specialized service processor that monitors the physical state of a computer, network server, or other hardware device using sensors and communicating with the system administrator through an independent connection. The BMC is configured on the motherboard or main circuit board of the device to be monitored. The sensors of a BMC can measure internal physical variables such as temperature, humidity, power-supply voltage, fan speeds, communications parameters and operating system (OS) functions.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computing system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an application programming interface (API). An API can define one or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, and the like.

According to an exemplary benefit of the present disclosure, personalized guidance is provided via a tailored career transition plan that is based on individual assessments, which ensure relevance and effectiveness. According to another exemplary benefit of the present disclosure, enhanced support is provided via features, such as user support and curated resources, that provide comprehensive support through the transition process. According to yet another exemplary benefit of the present disclosure, up-to-date information is provided via curation of publicly available information that ensures that users to have access to the latest and most relevant data. According to yet another exemplary benefit of the present disclosure, efficiency is achieved via a custom resumé generation and curated job search terms that streamline the job application process (e.g., saving time and increasing likelihood of success).

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art. Numerous changes to the disclosed embodiments can be made in accordance with the disclosure herein, without departing from the spirit or scope of the disclosure. Thus, the breadth and scope of the present disclosure should not be limited by any of the above described embodiments.

Although certain aspects and features of the present disclosure have been illustrated and described with respect to one or more implementations, equivalent alterations and modifications will occur or be known to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only, and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

One or more elements or aspects or steps, or any portion(s) thereof, from one or more of any of the claims below can be combined with one or more elements or aspects or steps, or any portion(s) thereof, from one or more of any of the other claims below or combinations thereof, to form one or more additional implementations and/or claims of the present disclosure.

1. A computer-implemented method, comprising:
receiving personal information associated with a user;
generating a user profile associated with the user based at least in part on the received personal information, the user profile indicative of one or more career transition goals or retention goals;
analyzing the user profile to generate a set of key parameters;
generating a customized career plan based at least in part on the user profile and the key parameters; and
outputting a graphical user interface showing the customized career plan.

2. The computer-implemented method of claim 1, wherein generating the customized career plan includes accessing publicly available information from one or more publicly available resources.

3. (canceled)

4. The computer-implemented method of claim 1, wherein the user profile includes (i) demographic information, (ii) health-related information, (iii) career-related information, (iv) information about the user's family, (v) information about the user's finances, or (vi) any combination of (i)-(v).

5. The computer-implemented method of claim 1, wherein the set of key parameters includes (i) information about family and dependents of the user, (ii) information about current financial assets and liabilities of the user, (iii) information about a desired career transition timeframe for the user, (iv) information about a preferred location for a career transition for the user, (v) information about motivations and reasons for the one or more career transition goals of the user, or (vi) any combination of (i)-(v).

6. The computer-implemented method of claim 1, wherein generating the career plan includes identifying one or more available resources as being beneficial for the user to achieve the one or more career transition goals or military retention goals, wherein the career plan includes a recommendation associated with the identified one or more available resources.

7. The computer-implemented method of claim 1, wherein generating the career plan includes identifying one or more potential career targets based at least in part on the user profile and the set of key parameters, wherein the career plan includes a recommendation associated with the identified one or more potential career targets.

8. The computer-implemented method of claim 1, further comprising receiving supplemental information from a support user, the supplemental information usable to (i) update the user profile, (ii) update the set of key parameters, (iii) update the career transition plan, (iv) update progress of one or more steps of the career transition plan, or (v) any combination of (i)-(iv).

9. The computer-implemented method of claim 1, further comprising:
receiving tracking information indicative of progress of one or more steps of the career plan; and
updating the graphical user interface based at least in part on the tracking information.

10. The computer-implemented method of claim 1, further comprising:
receiving tracking information indicative of progress of one or more steps of the career plan; and
updating the career transition plan based at least in part on the tracking information.

11. The computer-implemented method of claim 1, further comprising generating customized materials associated with the career plan.

12. The computer-implemented method of claim 11, wherein generating the customized materials includes generating a customized resumé associated with the user based at least in part on the user profile and the key parameters.

13. The computer-implemented method of claim 12, wherein generating the customized resumé is further based at least in part on a selected career target.

14. The computer-implemented method of claim 1, further comprising generating a user persona associated with the user based at least in part on the received personal information, the user persona indicative of a career or military status of the user.

15. A system comprising:
a control system including one or more processors; and
a memory having stored thereon machine readable instructions;
wherein the control system is coupled to the memory, and wherein the one or more processors are configured to execute the machine readable instructions to perform operations including:
receiving personal information associated with a user;
generating a user profile associated with the user based at least in part on the received personal information, the user profile indicative of one or more career transition goals or retention goals;
analyzing the user profile to generate a set of key parameters;
generating a customized career plan based at least in part on the user profile and the key parameters; and
outputting a graphical user interface showing the customized career plan.

16. The system of claim 15, wherein the operations further include:
receiving tracking information indicative of progress of one or more steps of the career plan; and
updating the graphical user interface based at least in part on the tracking information.

17. The system of claim 15, wherein the operations further include generating customized materials associated with the career plan.

18. (canceled)

19. (canceled)

20. A computer program product embodied on a non-transitory computer readable medium and comprising instructions which, when executed by a computer, cause the computer to carry out operations including:
receiving personal information associated with a user;
generating a user profile associated with the user based at least in part on the received personal information, the user profile indicative of one or more career transition goals or retention goals;
analyzing the user profile to generate a set of key parameters;
generating a customized career plan based at least in part on the user profile and the key parameters; and
outputting a graphical user interface showing the customized career transition plan.

21. The computer-implemented method of claim 2, wherein accessing the publicly available information includes:
curating the publicly available information from the publicly available resources based on (i) the parameters of the user profile, (ii) the personal information of the user, (iii) the customized career plan, or (iv) any combination of (i)-(iii); and
updating the customized career plan based on the curated publicly available information.

22. The computer-implemented method of claim 2, wherein the publicly available resources include (i) health databases associated with the user, (ii) grant programs, (iii) vocational training programs, (iv) financial records, (v), demographic records, (v), military records, (vi), employment records, (vii) personal information associated with a user device associated with the user, or (viii) any combination of (i)-(vii).

23. The computer-implemented method of claim 2, wherein the publicly available resources are associated with a computing system associated with a first party, the first party being an organization associated with the user.
